(19) United States
(12) Patent Application Publication
(10) Pub. No.: US 2026/0237770 A1
(43) Pub. Date: Aug. 13, 2026

(54) BATTERY SYSTEM

(71) Applicant: TOYOTA JIDOSHA KABUSHIKI KAISHA, Toyota-shi (JP)

(72) Inventors: Yoshinori AOKI, Nagoya-shi (JP); Kazuyasu IWATA, Toyohashi-shi (JP); Yosuke TANEBAYASHI, Toyota-shi (JP)

(73) Assignee: TOYOTA JIDOSHA KABUSHIKI KAISHA, Toyota-shi (JP)

(21) Appl. No.: 19/456,491

(22) Filed: Jan. 22, 2026

(30) Foreign Application Priority Data
Feb. 10, 2025 (JP) 2025-020029

(51) Int. Cl. H01M 10/48; H01M 10/42; H01M 10/613; H01M 10/615; H01M 10/625; H01M 10/633; H01M 10/653; H01M 10/655

(52) U.S. Cl. CPC H01M 10/486; H01M 10/425; H01M 10/613; H01M 10/615; H01M 10/625; H01M 10/633; H01M 10/653; H01M 10/655; H01M 2010/4271

(57) ABSTRACT

An ECU executes a process including: acquiring a temperature distribution of the battery while the vehicle is stopped; setting a normal range and an abnormal range; performing heating control using ripple current; acquiring the temperature distribution after heating; determining whether there is an abnormality in the temperature change; and determining that delamination of the thermally conductive material has occurred when it is determined that there is an abnormality in the temperature change.

### CROSS-REFERENCE TO RELATED APPLICATION

This application claims priority to Japanese Patent Application No. 2025-020029 filed on February 10, 2025. The disclosure of the above-identified application, including the specification, drawings, and claims, is incorporated by reference herein in its entirety.

### BACKGROUND

### 1. Technical Field

The present disclosure relates to battery systems.

### 2. Description of Related Art

Japanese Unexamined Patent Application Publication No. 2021-064488 (JP 2021-064488 A) discloses a technique in which, when no abnormality has been detected in an air-conditioning system and a detection value of a temperature sensor is higher than a predetermined value, it is determined that an abnormality has occurred in a refrigerant system of a cooling device.

### SUMMARY

When a battery system includes, for example, a battery and a heat exchange member with a thermally conductive material provided between the battery and the heat exchange member, poor coating of the thermally conductive material may cause delamination of the thermally conductive material as a result of external shocks from traveling over rough roads. If delamination of the thermally conductive material occurs, the battery can no longer be regulated to an appropriate temperature. Because the condition of the thermally conductive material cannot be checked from outside the battery system, it is desired to accurately determine whether delamination of the thermally conductive material has occurred.

The present disclosure has been made to address the above issue, and an object thereof is to provide a battery system that accurately determines whether delamination of a thermally conductive material has occurred.

A battery system according to one aspect of the present disclosure includes: a secondary battery; a heat exchange member configured to exchange heat with the secondary battery; a thermally conductive material disposed between the secondary battery and the heat exchange member; a ripple current generation device configured to generate ripple current in the secondary battery; a detection device configured to detect the temperature of the secondary battery; and a control device configured to perform heating control in which the secondary battery is heated by generating the ripple current in the secondary battery. The control device is configured to determine that the thermally conductive material has not delaminated from either the heat exchange member or the secondary battery when the temperature of the secondary battery after the heating control falls within a first temperature range. The first temperature range is set using the amount of heat generated by the ripple current. The control device is configured to determine that the thermally conductive material has delaminated from either or both of the heat exchange member and the secondary battery when the temperature of the secondary battery after the heating control falls within a second temperature range that is higher than the first temperature range.

With this configuration, a certain amount of heat can be applied to the secondary battery by generating ripple current in the secondary battery to heat it. Accordingly, the first temperature range and the second temperature range can be distinguished from each other. The presence or absence of delamination of the thermally conductive material can thus be accurately determined based on whether the temperature after the heating falls within the first temperature range or within the second temperature range that is higher than the first temperature range.

In one embodiment, the battery system further includes a cooling device configured to cool the heat exchange member. The control device is configured to perform cooling control in which the heat exchange member is cooled using the cooling device during the heating control, and to determine that the thermally conductive material has not delaminated when the temperature of the secondary battery after the heating control falls within a third temperature range that is lower than the first temperature range.

With this configuration, by performing the cooling control, the second temperature range and the third temperature range can be more clearly distinguished from each other. Therefore, the presence or absence of delamination of the thermally conductive material can be accurately determined based on whether the temperature after the heating falls within the third temperature range that is lower than the first temperature range.

In still another embodiment, the battery system is mounted on a vehicle. The control device is configured to determine, while the vehicle is stopped, whether the thermally conductive material has delaminated.

With this configuration, the presence or absence of delamination of the thermally conductive material can be determined not only while the vehicle is in operation etc. but also while the vehicle is stopped. Therefore, opportunities to determine the presence or absence of delamination of the thermally conductive material can be increased.

The present disclosure provides a battery system that can accurately determine whether delamination of a thermally conductive material has occurred.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 shows an example of the configuration of a vehicle equipped with a battery system according to an embodiment of the present disclosure;

FIG. 2 illustrates an example of a method for determining whether delamination of a thermally conductive material has occurred;

FIG. 3 is a flowchart of an example of a process executed by an electronic control unit (ECU);

FIG. 4 illustrates the operation of the ECU in the embodiment;

FIG. 5 is a flowchart of an example of a process executed by an ECU in a modification; and

FIG. 6 illustrates the operation of the ECU in the modification.

### DETAILED DESCRIPTION OF EMBODIMENTS

An embodiment of the present disclosure will be described in detail below with reference to the drawings. The same or corresponding portions are denoted by the same signs throughout the drawings, and description thereof will not be repeated.

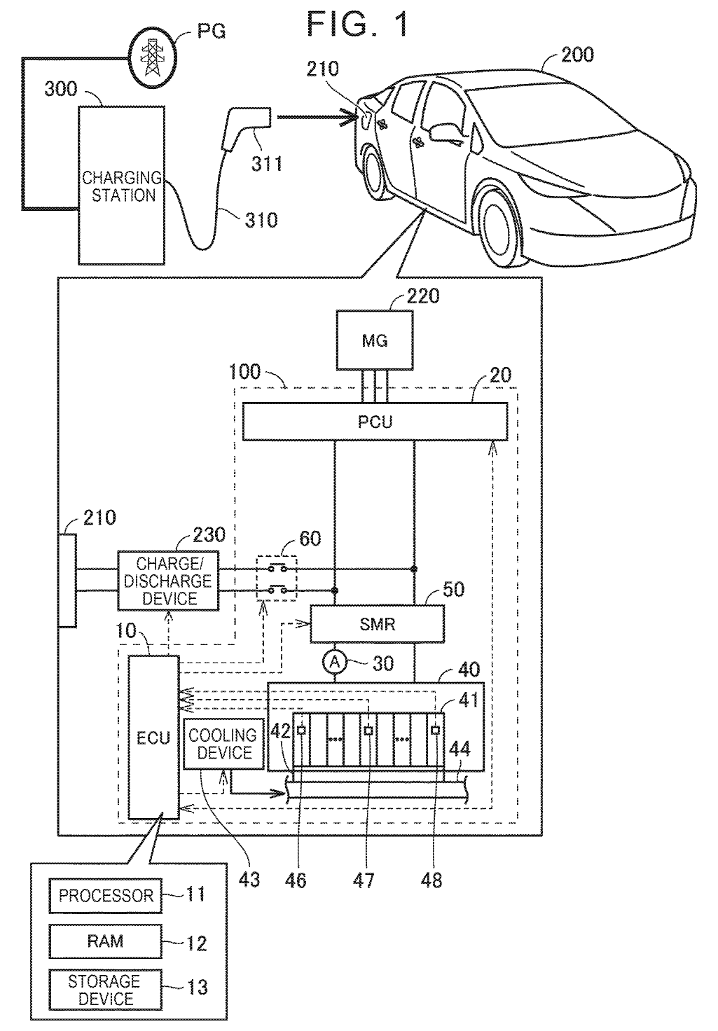

FIG. 1 shows an example of the configuration of a vehicle 200 equipped with a battery system 100 according to an embodiment of the present disclosure.

The vehicle 200 can transfer electric power to and from a charging station 300 (that is, perform charging and discharging) when electrically connected to the charging station 300 through a cable 310. Alternating current power is transferred between a connector 311 provided at an end of the cable 310 and the vehicle 200. The charging station 300 transfers electric power to and from a power grid PG.

The vehicle 200 is equipped with the battery system 100, an inlet 210, a motor generator (MG) 220, and a charge/discharge device 230.

The vehicle 200 is configured to run on electric power stored in a battery 40 of the battery system 100. The vehicle 200 may be, for example, a battery electric vehicle (BEV) without an engine (internal combustion engine). However, the vehicle 200 is not limited to a BEV, and may be a plug-in hybrid electric vehicle (PHEV) equipped with an internal combustion engine, or another type of electrified vehicle (xEV).

The inlet 210 is provided on an exterior portion of the vehicle 200 and has a shape that can mate with the connector 311. The exterior portion includes a lid. When the inlet 210 is not in use, the lid is closed. The inlet 210 is thus covered by the lid, and exposure of the inlet 210 to the outside is suppressed.

The MG 220 is, for example, a three-phase alternating current rotating electrical machine. The MG 220 functions as a traction motor for the vehicle 200. The MG 220 is driven by alternating current power from the battery system 100 and rotates the drive wheels of the vehicle 200. The MG 220 also performs regenerative power generation and outputs the generated alternating current power to the battery system 100. The number of traction motors provided in the vehicle 200 is not particularly limited to one and may be two or more.

The charge/discharge device 230 is connected to the inlet 210 and the battery system 100 (specifically, a relay 60). The charge/discharge device 230 performs power conversion when electric power is transferred between the charging station 300 and the battery system 100. For example, the charge/discharge device 230 converts alternating current power supplied from the charging station 300 into direct current power and supplies it to the battery system 100, or converts direct current power supplied from the battery system 100 into alternating current power and supplies it to the charging station 300. The charge/discharge device 230 includes a power conversion circuit (for example, an inverter and a converter) and is configured to adjust the charging current or the discharging current.

The battery system 100 includes an electronic control unit (ECU) 10, a power control unit (PCU) 20, a battery 40, a thermally conductive material 42, a cooling device 43, a heat exchange member 44, temperature sensors 46, 47, and 48, a system main relay (SMR) 50, and a relay 60.

The ECU 10 includes a processor 11, a random access memory (RAM) 12, and a storage device 13. The storage device 13 is configured to retain stored information. The storage device 13 stores programs and information to be used by the programs (for example, maps, formulas, and various parameters). In the present embodiment, the processor 11 executes the programs stored in the storage device 13, enabling the ECU 10 to perform various processes. These processes may be executed by hardware (electronic circuits) without using software. The ECU 10 controls, for example, the operations of the charge/discharge device 230, the PCU 20, the cooling device 43, the SMR 50, and the relay 60.

The battery 40 includes a plurality of energy storage cells 41. A predetermined number of energy storage cells 41 are arranged along, for example, the thickness direction of the energy storage cells 41 (the left-right direction in the plane of FIG. 1). The predetermined number is not limited to any particular value. The energy storage cells 41 are secondary cells, and are typically lithium-ion secondary cells. Lithium-ion secondary cells use lithium as the charge carrier and may include both lithium-ion secondary cells using a liquid electrolyte but also all-solid-state cells using a solid electrolyte.

The temperature sensors 46, 47, and 48 are provided respectively on the energy storage cells 41 at one end, the middle, and the other end of the arrangement of the energy storage cells 41. The temperature sensors 46, 47, and 48 are all connected to the ECU 10. Each of the temperature sensors 46, 47, and 48 detects the temperature of a respective target object (energy storage cell 41) and outputs a signal indicating the detected temperature to the ECU 10.

The heat exchange member 44. The thermally conductive material 42 may be formed of, for example, a silicone-based adhesive. The thermally conductive material 42 may alternatively be, for example, a thermally conductive gel, grease, paste, or sheet that can adhere to the energy storage cells 41 and the heat exchange member 44. The heat exchange member 44 may be, for example, a heat sink. The temperature of the battery 40 is regulated by cooling the heat sink with the cooling device 43. The cooling device 43 may be, for example, a blower such as a fan that air-cools the heat sink, or a blower such as a fan that air-cools a heat exchanger connected to a circulation path through which a cooling medium flows inside the heat sink.

The SMR 50 connects and disconnects the power line between the battery 40 and the PCU 20 in response to a control signal received from the ECU 10. The SMR 50 is closed (connected) when the vehicle 200 is traveling. The SMR 50 is also closed when electric power is transferred between the battery 40 and the inlet 210 (and the charging station 300). The SMR 50 is also closed when heating control using ripple current, which will be described later, is performed.

The relay 60 is located between the charge/discharge device 230 and the battery 40. The relay 60 connects and disconnects the power line (charge/discharge line) between the inlet 210 and the battery 40 in response to a control signal received from the ECU 10.

In the present embodiment, the charge/discharge line that passes through the inlet 210, the charge/discharge device 230, and the relay 60 is connected to the power line connecting the SMR 50 and the PCU 20. That is, the charge/discharge line is connected such that the charge/discharge device 230 is connected in parallel with the PCU 20 relative to the SMR 50. However, the disclosure is not limited to this. The charge/discharge line may be connected to the power line connecting the battery 40 and the SMR 50. That is, the charge/discharge line may be connected such that the charge/discharge device 230 is connected in parallel with the SMR 50 relative to the battery 40.

When the vehicle 200 is in a plugged-in state, external charging (i.e., charging of the battery 40 with electric power from the charging station 300) and external discharging (i.e., discharging of electric power from the battery 40 to the charging station 300) can be performed. The vehicle 200 may alternatively be configured to perform external charging alone. When external charging or external discharging is performed, the relay 60 is closed (connected), and when neither external charging nor external discharging is performed, the relay 60 is opened (disconnected).

The PCU 20 includes a circuit (for example, an inverter and a converter) that drives the MG 220 using electric power supplied from the battery 40. The inverter and the converter are formed by, for example, a combination of a plurality of switching elements. The inverter and the converter perform switching operations such as converting electric power, boosting voltage, or generating ripple current (described later) in response to control signals received from the ECU 10.

For example, when the battery 40 is to be heated, the ECU 10 controls the PCU 20 to generate ripple current. The ECU 10 causes the generated ripple current to flow through each of the energy storage cells 41 constituting the battery 40, thereby producing current ripple and raising the temperature of each of the energy storage cells 41 using the generated Joule heat. The ripple current is generated by switching control of the switching elements in the PCU 20 (for example, in the inverter) performed in response to a control signal from the ECU 10. For example, the ECU 10 may adjust the frequency of the ripple current by adjusting the on-off cycle of the switching elements. A known technique may be used for generating ripple current, and detailed description thereof is omitted. In the present embodiment, ripple current is described as being generated in the PCU 20. However, it may alternatively be generated in the charge/discharge device 230. In the present embodiment, the PCU 20 corresponds to the "ripple current generation device."

In the vehicle 200 having the configuration described above, the thermally conductive material 42 is provided between the battery 40 and the heat exchange member 44. Poor coating of the thermally conductive material 42 may cause delamination of the thermally conductive material 42 as a result of external shocks from traveling over rough roads. If the thermally conductive material 42 adhering to either or both of the battery 40 and the heat exchange member 44 delaminates, the battery 40 can no longer be regulated to an appropriate temperature. Because the condition of the thermally conductive material 42 cannot be checked from outside the battery system 100, it is desired to accurately determine whether the thermally conductive material 42 has delaminated from either or both of the battery 40 and the heat exchange member 44, or whether the thermally conductive material 42 has not delaminated from either the battery 40 or the heat exchange member 44.

Accordingly, the ECU 10 may determine whether delamination of the thermally conductive material 42 has occurred by checking, for example, when the battery 40 itself generates heat during vehicle travel, external charging, or external discharging, whether the temperature after heating falls within the temperature range for the normal state in which no delamination of the thermally conductive material 42 has occurred, or within the temperature range for the abnormal state in which delamination has occurred.

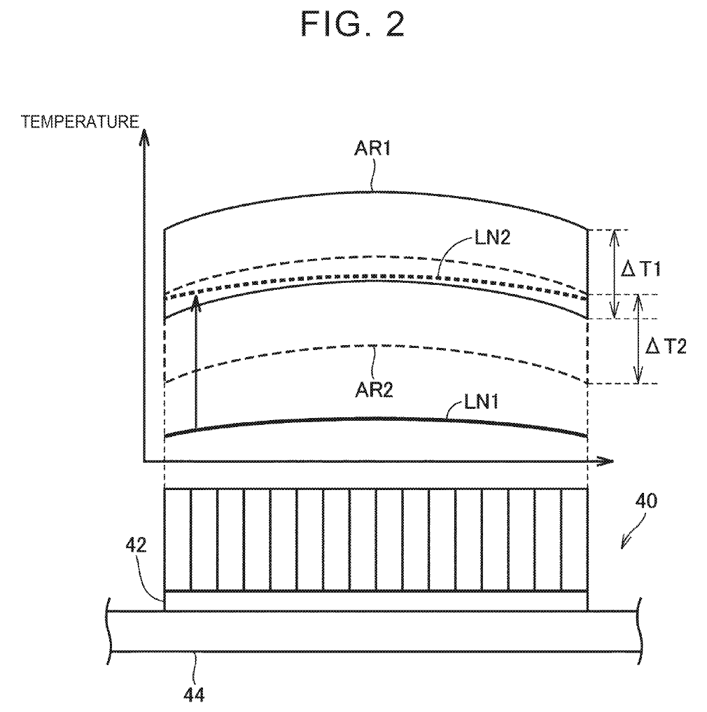

FIG. 2 illustrates an example of a method for determining whether delamination of the thermally conductive material 42 has occurred. The lower part of FIG. 2 shows the battery 40, the thermally conductive material 42, and the heat exchange member 44. The upper part of FIG. 2 shows: a temperature distribution LN1 before heating (thick continuous line), measured across the energy storage cells 41 from one end to the other end of the battery 40 shown in the lower part of FIG. 2; a temperature distribution LN2 after heating (thick dashed line), measured across the energy storage cells 41; a temperature range AR1 (continuous frame), assumed for the case where the thermally conductive material 42 is in the abnormal state after heating; and a temperature range AR2 (dashed frame), assumed for the case where the thermally conductive material 42 is in the normal state after heating. As an example, the temperature range AR1 in FIG. 2 is shown as having a certain width ΔT1 from its upper limit to its lower limit, and the temperature range AR2 in FIG. 2 is shown as having a certain width ΔT2 from its upper limit to its lower limit. When delamination of the thermally conductive material 42 occurs, heat from the energy storage cells 41 is less likely to be transferred to the heat exchange member 44. Accordingly, after the heating control, a greater temperature rise is expected compared with the normal state. The ECU 10 executes a process of determining whether delamination of the thermally conductive material 42 has occurred (i.e., whether the thermally conductive material 42 is in the normal state or in the abnormal state) using the temperature distributions LN1, LN2 before and after the heating control, the temperature range AR1 assumed for the abnormal state after heating, and the temperature range AR2 assumed for the normal state after heating.

For example, the ECU 10 acquires the temperature distribution LN1 shown in FIG. 2 by using the detection results of the temperature sensors 46, 47, and 48 before the vehicle 200 travels or before external charging or external discharging of the battery 40 is performed. After the vehicle 200 has traveled or after external charging or external discharging of the battery 40 has been performed, the ECU 10 acquires the temperature distribution LN2 shown in FIG. 2 by using the detection results of the temperature sensors 46, 47, and 48. The ECU 10 estimates a temperature range AR1 into which the temperature distribution LN1, obtained before the battery 40 itself generates heat, may shift after the battery 40 itself has generated heat as a result of a certain amount of vehicle travel, external charging, or external discharging, when the thermally conductive material 42 is in the abnormal state with delamination. The ECU 10 also estimates a temperature range AR2 into which the temperature distribution LN1, obtained before the battery 40 itself generates heat, may shift after the battery 40 itself has generated heat, when the thermally conductive material 42 is in the normal state with no delamination. Specifically, the ECU 10 estimates the amount of heat generated based on the amount of electric power consumed from the start to the end of the vehicle travel, external charging, or external discharging, and estimates the temperature ranges AR1, AR2 based on the estimated amount of heat. When the temperature distribution LN2 obtained after the battery 40 itself has generated heat falls within the temperature range AR2, the ECU 10 determines that the thermally conductive material 42 is in the normal state with no delamination. When the temperature distribution LN2 obtained after the battery 40 itself has generated heat falls within the temperature range AR1, the ECU 10 determines that the thermally conductive material 42 is in the abnormal state with delamination.

However, since the amount of heat generated by the battery 40 itself varies greatly depending on the traveling load etc., an overlap may occur between the temperature range AR1 and the temperature range AR2, as shown in FIG. 2. In this case, when the temperature distribution LN2 obtained after the battery 40 itself has generated heat falls within the overlapping portion between the temperature range AR1 and the temperature range AR2, it may not be possible to accurately determine whether delamination of the thermally conductive material 42 has occurred.

Accordingly, in the present embodiment, the ECU 10 performs heating control by supplying ripple current. When, after the heating control, the temperature of the battery 40 falls within the range for the normal state, the ECU 10 determines that no delamination of the thermally conductive material 42 has occurred. When the temperature falls within the range for the abnormal state, which is higher than the range for the normal state, the ECU 10 determines that delamination of the thermally conductive material 42 has occurred.

With this configuration, a certain amount of heat can be applied to the battery 40 by generating ripple current in the battery 40 to heat it. Accordingly, the temperature range for the normal state and the temperature range for the abnormal state can be distinguished from each other. Accordingly, the presence or absence of delamination of the thermally conductive material 42 can be accurately determined based on whether the temperature after the heating falls within the temperature range for the normal state or within the temperature range for the abnormal state that is higher than the temperature range for the normal state.

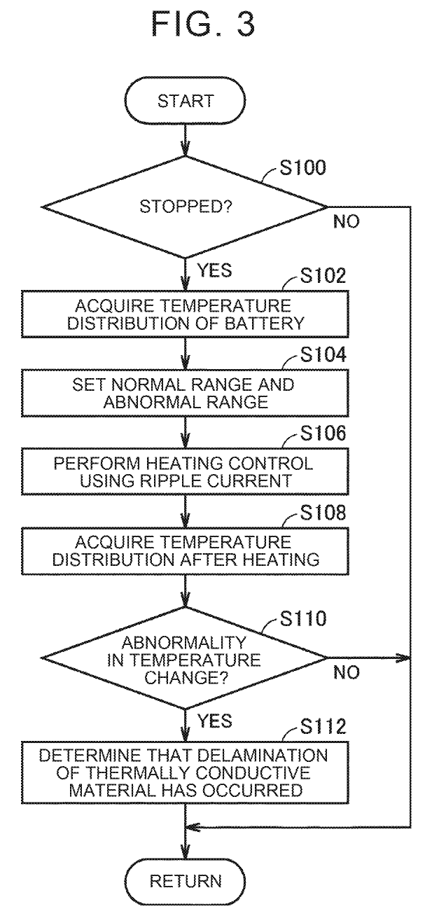

An example of a process executed by the ECU 10 will now be described with reference to FIG. 3. FIG. 3 is a flowchart showing an example of the process executed by the ECU 10.

In step 100 (hereinafter, "step" will be denoted as "S"), the ECU 10 determines whether the vehicle 200 is stopped. For example, the ECU 10 may determine that the vehicle 200 is stopped when the speed of the vehicle 200 is zero or less than or equal to a threshold, may determine that the vehicle 200 is stopped when the rotational speed of the MG 220 is zero or less than or equal to a threshold, or may determine that the vehicle 200 is stopped when the connector 311 is attached to the inlet 210. When it is determined that the vehicle 200 is stopped (YES in S100), the process proceeds to S102.

In S102, the ECU 10 acquires, using the temperature sensors 46, 47, and 48, the temperature distribution of the battery 40 corresponding to LN1 in FIG. 2. The process then proceeds to S104.

In S104, the ECU 10 sets, using the acquired temperature distribution, a temperature range after heating (normal range) for the case where the thermally conductive material 42 is in the normal state with no delamination, and a temperature range after heating (abnormal range) for the case where the thermally conductive material 42 is in the abnormal state with delamination. For example, the ECU 10 may set the normal range corresponding to the temperature range AR2 in FIG. 2 (hereinafter referred to as temperature range AR4) as follows. The lower limit of the normal range is set to a value obtained by adding a predetermined first value to the temperature distribution acquired in S102 as a reference, and the upper limit of the normal range is set to a value obtained by adding a predetermined second value to the temperature distribution. Similarly, the ECU 10 may set the abnormal range corresponding to the temperature range AR1 in FIG. 2 (hereinafter referred to as temperature range AR3) as follows. The lower limit of the abnormal range is set to a value obtained by adding a predetermined third value to the temperature distribution acquired in S102 as a reference, and the upper limit of the abnormal range is set to a value obtained by adding a predetermined fourth value to the temperature distribution. The process then proceeds to S106.

In S106, the ECU 10 performs heating control using ripple current. Since the heating control using ripple current has already been described above, detailed description thereof will not be repeated. The ECU 10 generates ripple current in the battery 40 such that a predetermined amount of heat (i.e., the amount of heat at which the thermally conductive material 42 is in the normal state and the acquired temperature distribution rises into the normal range AR4) is generated in the battery 40. The process then proceeds to S108.

In S108, the ECU 10 acquires, using the temperature sensors 46, 47, and 48, the temperature distribution of the battery 40 after heating, corresponding to LN2 in FIG. 2. The process then proceeds to S110.

In S110, the ECU 10 determines whether there is an abnormality in the temperature change. For example, the ECU 10 determines that there is no abnormality in the temperature change when the temperature distribution of the battery 40 after heating falls within the normal range. The ECU 10 determines that there is an abnormality in the temperature change when the temperature distribution of the battery 40 after heating falls within the abnormal range. When it is determined that there is an abnormality in the temperature change (YES in S110), the process proceeds to S112.

In S112, the ECU 10 determines that delamination of the thermally conductive material 42 has occurred. For example, the ECU 10 may set a diagnostic flag indicating that the thermally conductive material 42 has delaminated to ON, or may turn on a predetermined warning lamp or notify the user that delamination has occurred. The process then ends. When it is determined that the vehicle is not stopped (NO in S100) or that there is no abnormality in the temperature change (NO in S110), the process also ends.

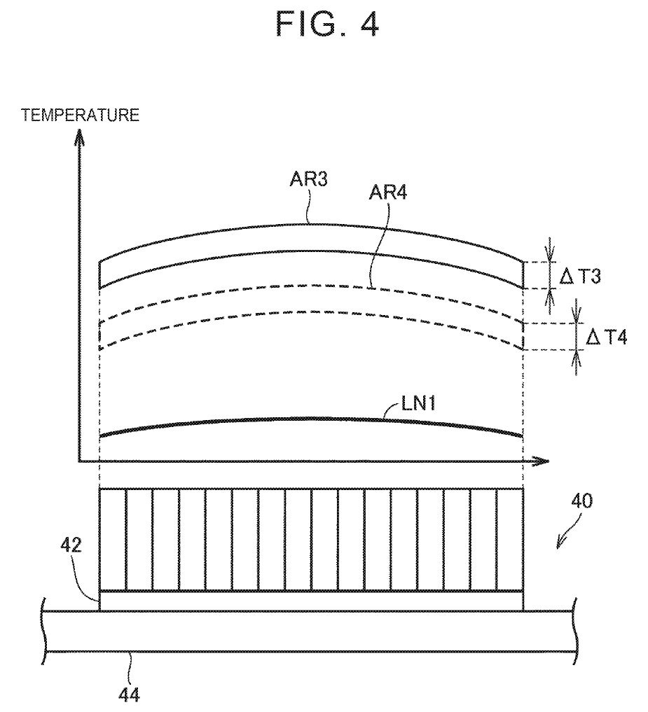

The operation of the ECU 10 based on the above-described structure and flowchart will now be described with reference to FIG. 4. FIG. 4 illustrates the operation of the ECU 10 in the present embodiment. The lower part of FIG. 4 shows the battery 40, the thermally conductive material 42, and the heat exchange member 44. The upper part of FIG. 4 shows: the temperature distribution LN1 before heating (thick continuous line), measured across the energy storage cells 41 from one end to the other end of the battery 40 shown in the lower part of FIG. 4; the temperature range AR3 (continuous frame), assumed for the case where the thermally conductive material 42 is in the abnormal state after heating; and the temperature range AR4 (dashed frame), assumed for the case where the thermally conductive material 42 is in the normal state after heating.

When the vehicle 200 is stopped (YES in S100), the temperature distribution LN1 of the battery 40 is acquired using the detection results of the temperature sensors 46, 47, and 48 (S102). Then, the temperature range AR3 for determining that the thermally conductive material 42 is in the abnormal state after heating control using ripple current, and the temperature range AR4 for determining that the thermally conductive material 42 is in the normal state after the heating control using ripple current, are set (S104).

When heating control using ripple current is performed while the vehicle 200 is stopped, a certain amount of heat is generated without being affected by disturbances. Therefore, the variation in temperature rise is small. Accordingly, the temperature range AR3 has a temperature width ΔT3 smaller than the temperature width ΔT1 of the temperature range AR1 in FIG. 2, and the temperature range AR4 has a temperature width ΔT4 smaller than the temperature width ΔT2 of the temperature range AR2 in FIG. 2. As a result, the temperature range AR3 is higher than the temperature range AR4 and does not overlap with the temperature range AR4.

Subsequently, heating control using ripple current is performed (S106), and the temperature distribution after heating, corresponding to LN2 in FIG. 2, is acquired (S108). When the acquired temperature distribution falls within the temperature range AR3, it is determined that there is an abnormality in the temperature change (YES in S110), and it is determined that delamination of the thermally conductive material 42 has occurred (S112). On the other hand, when the acquired temperature distribution falls within the temperature range AR4, it is determined that there is no abnormality in the temperature change (NO in S110).

As described above, with the battery system 100 of the present embodiment, a certain amount of heat can be applied to the battery 40 by generating ripple current in the battery 40 to heat it. Accordingly, the temperature range for the abnormal state of the thermally conductive material 42 and the temperature range for the normal state of the thermally conductive material 42 can be accurately estimated. The presence or absence of delamination of the thermally conductive material 42 can thus be accurately determined based on whether the temperature after the heating falls within the temperature range for the normal state or within the temperature range for the abnormal state that is higher than the temperature range for the normal state.

Furthermore, the presence or absence of delamination of the thermally conductive material 42 can be determined not only during travel of the vehicle 200, external charging, or external discharging but also while the vehicle 200 is stopped. Therefore, opportunities to determine the presence or absence of determination of the thermally conductive material 42 can be increased.

Next, modifications will be described. In the above embodiment, it is described that the normal range and the abnormal range after heating are set by performing heating control using ripple current. However, heating control using ripple current may be performed in combination with cooling control using the cooling device.

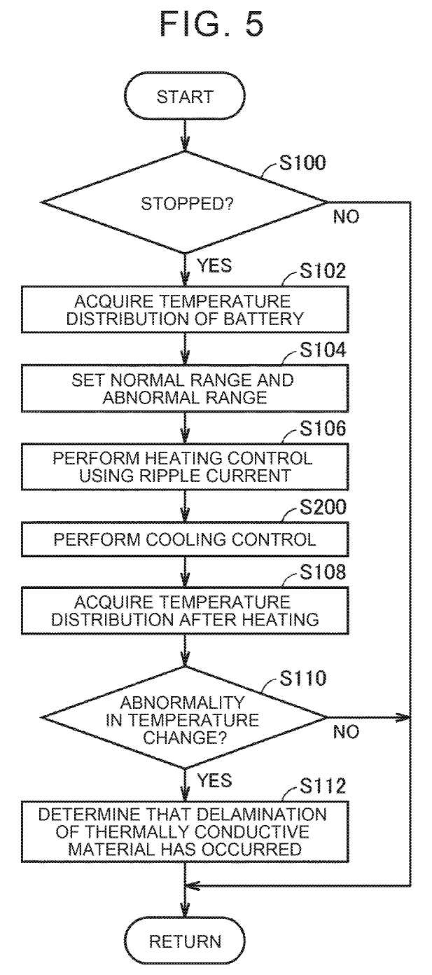

FIG. 5 is a flowchart of an example of a process executed by the ECU 10 in a modification. In the flowchart shown in FIG. 5, the same steps as in the flowchart of FIG. 3 are denoted by the same step numbers, and therefore the contents of those steps are also the same except where otherwise described below. Accordingly, detailed description thereof will not be repeated.

After heating control using ripple current is performed (S106), the process proceeds to S200. In S200, the ECU 10 performs cooling control. The ECU 10 cools the heat exchange member 44 using the cooling device 43 The process then proceeds to S108.

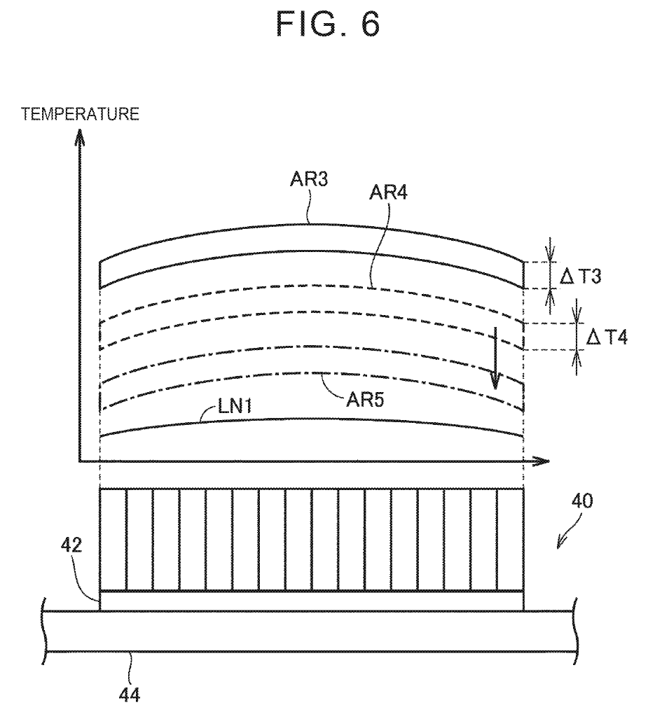

The operation of the ECU 10 in this case will be described with reference to FIG. 6. FIG. 6 illustrates the operation of the ECU 10 in the modification. FIG. 6 is the same as FIG. 4 except that a temperature range AR5 is set between the temperature range AR4 and the temperature distribution LN1, and therefore detailed description thereof will not be repeated. The temperature range AR5 is a temperature range assumed for the case where the thermally conductive material 42 is in the normal state after heating control using ripple current and cooling control are performed.

When the vehicle 200 is stopped (YES in S100), the temperature distribution LN1 of the battery 40 is acquired using the detection results of the temperature sensors 46, 47, and 48 (S102). Then, the temperature range AR3 for determining that the thermally conductive material 42 is in the abnormal state after heating control using ripple current and cooling control, and the temperature range AR5 for determining that the thermally conductive material 42 is in the normal state after the heating control using ripple current and the cooling control, are set (S104).

When heating control using ripple current is performed while the vehicle 200 is stopped, a certain amount of heat is generated without being affected by load fluctuations and disturbances. Therefore, the variation in temperature rise is small. When the thermally conductive material 42 is in the normal state with no delamination and heating control using ripple current is performed in combination with cooling control, the temperature range is expected to be AR5, which is lower than the temperature range AR4 in the case where no cooling control is performed. On the other hand, when the thermally conductive material 42 is in the abnormal state with delamination and heating control using ripple current is performed in combination with cooling control, the battery 40 is not cooled, and the temperature range is expected to be the same as the temperature range AR3 in the case where no cooling control is performed.

Subsequently, heating control using ripple current is performed (S106), and cooling control is performed (S200). The temperature distribution after heating, corresponding to LN2 in FIG. 2, is then acquired (S108). When the acquired temperature distribution falls within the temperature range AR3, it is determined that there is an abnormality in the temperature change (YES in S110), and it is determined that delamination of the thermally conductive material 42 has occurred (S112). On the other hand, when the acquired temperature distribution falls within the temperature range AR5, it is determined that there is no abnormality in the temperature change (NO in S110).

With this configuration, when cooling control is performed, the normal range (AR5) and the abnormal range (AR3) are separated to a greater extent compared to when cooling control is not performed. Therefore, whether delamination of the thermally conductive material 42 has occurred can be accurately determined.

In the above embodiment, the abnormal state in which delamination of the thermally conductive material 42 has occurred is described as, for example, a state in which the entire surface of the thermally conductive material 42 has delaminated (i.e., has become detached) from either or both of the battery 40 and the heat exchange member 44. However, the abnormal state may alternatively be classified into a plurality of stages for determination by, for example, setting an abnormal state in which part of the thermally conductive material 42 has delaminated.

The above embodiment illustrates an example in which the temperature sensors 46, 47, and 48 are respectively provided on the energy storage cells 41 at one end, the middle, and the other end of the arrangement of the energy storage cells 41 constituting the battery 40. However, the temperature sensors may be provided on four or more of the energy storage cells 41, or may be provided on all of the energy storage cells 41.

All or part of the modifications described above may be combined as appropriate. The embodiments disclosed herein should be considered to be illustrative in all respects and not restrictive. The scope of the present disclosure is set forth in the claims rather than in the above description, and is intended to include all modifications within the meaning and scope equivalent to the claims.

What is claimed is:

1. A battery system comprising:
a secondary battery;
a heat exchange member configured to exchange heat with the secondary battery;
a thermally conductive material disposed between the secondary battery and the heat exchange member;
a ripple current generation device configured to generate ripple current in the secondary battery;
a detection device configured to detect a temperature of the secondary battery; and
a control device configured to perform heating control in which the secondary battery is heated by generating the ripple current in the secondary battery,
wherein the control device is configured to determine that the thermally conductive material has not delaminated from either the heat exchange member or the secondary battery when the temperature of the secondary battery after the heating control falls within a first temperature range, the first temperature range being set using an amount of heat generated by the ripple current, and is configured to determine that the thermally conductive material has delaminated from either or both of the heat exchange member and the secondary battery when the temperature of the secondary battery after the heating control falls within a second temperature range that is higher than the first temperature range.

2. The battery system according to claim 1, further comprising a cooling device configured to cool the heat exchange member,
wherein the control device is configured to perform cooling control in which the heat exchange member is cooled using the cooling device during the heating control, and to determine that the thermally conductive material has not delaminated when the temperature of the secondary battery after the heating control falls within a third temperature range that is lower than the first temperature range.

3. The battery system according to claim 1, wherein:
the battery system is mounted on a vehicle; and
the control device is configured to determine, while the vehicle is stopped, whether the thermally conductive material has delaminated.
